(19) United States
(12) Patent Application Publication
(10) Pub. No.: US 2012/0162970 A1
(43) Pub. Date: Jun. 28, 2012

(54) ILLUMINATED PORTABLE MAKEUP MIRROR

(76) Inventor: LETHA JUNE BICHREST, Lumberton, TX (US)

(21) Appl. No.: 13/306,785

(22) Filed: Nov. 29, 2011

Related U.S. Application Data
(60) Provisional application No. 61/426,820, filed on Dec. 23, 2010.

(51) Int. Cl. F21V 33/00

(52) U.S. Cl. 362/135

(57) ABSTRACT

An illuminated makeup mirror having a makeup application tutorial to aid in proper makeup application. The portable mirror includes a housing having an upper lid, a lower lid, and a hinge connecting the upper lid to the lower lid. A closure latch secures the upper lid to the lower lid. A mirror is connected to the upper lid and a plurality of lights surround the mirror. A tutorial is attached to the lower lid and includes written instructions on how to apply makeup.

### CROSS-REFERENCE TO RELATED APPLICATIONS

This application claims the benefit of priority to U.S. Provisional Application No. 61/426,820 filed Dec. 23, 2010, the contents of which are incorporated herein by reference.

### BACKGROUND OF THE INVENTION

The present invention generally relates to an illuminated portable mirror. More particularly, the present invention relates to an illuminated portable mirror that helps the user to properly apply makeup.

Portable mirrors are a necessity for traveling women for carefully applying makeup. Traveling women are often required to consistently apply makeup in a professional manner with high-fashion looks and quality results, regardless of their location. Unfortunately, in view of the stress caused by the trip, women do not always consistently and properly apply makeup when traveling.

As can be seen, there is a need for a portable mirror that allows women to consistently and properly apply makeup, regardless of their location.

### SUMMARY OF THE INVENTION

In one aspect of the present invention, a portable mirror includes a housing having an upper lid, a lower lid, and a hinge connecting the upper lid to the lower lid; a closure latch secures the upper lid to the lower lid; a mirror is connected to the upper lid and a plurality of lights surround the mirror; a tutorial is attached to the lower lid and includes written instructions on how to apply makeup.

These and other features, aspects and advantages of the present invention will become better understood with reference to the following drawings, description and claims.

### BRIEF DESCRIPTION OF THE DRAWINGS

FIG. 1 is a perspective front view of an illuminated portable mirror according to an exemplary embodiment of the present invention showing the illuminated mirror in a closed position;

FIG. 2 is a perspective front view of the illuminated portable mirror of FIG. 1 showing the illuminated portable mirror in an open position;

FIG. 3 is a front view of the illuminated portable mirror of FIG. 1 showing the illuminated portable mirror in an open position;

FIG. 4 is a side view of the illuminated portable mirror of FIG. 1 showing the illuminated portable mirror in an open position; and

FIG. 5 is a schematic view of a makeup application tutorial according to the illuminated portable mirror of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an illuminated portable makeup mirror having a makeup application tutorial to aid in proper makeup application.

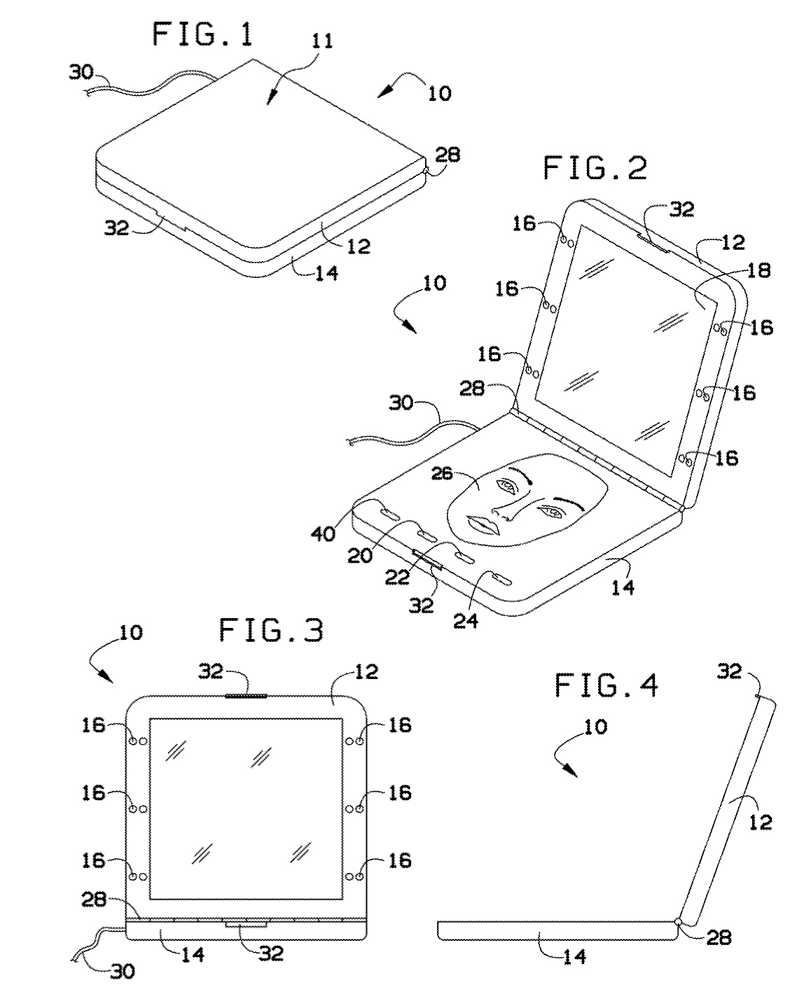

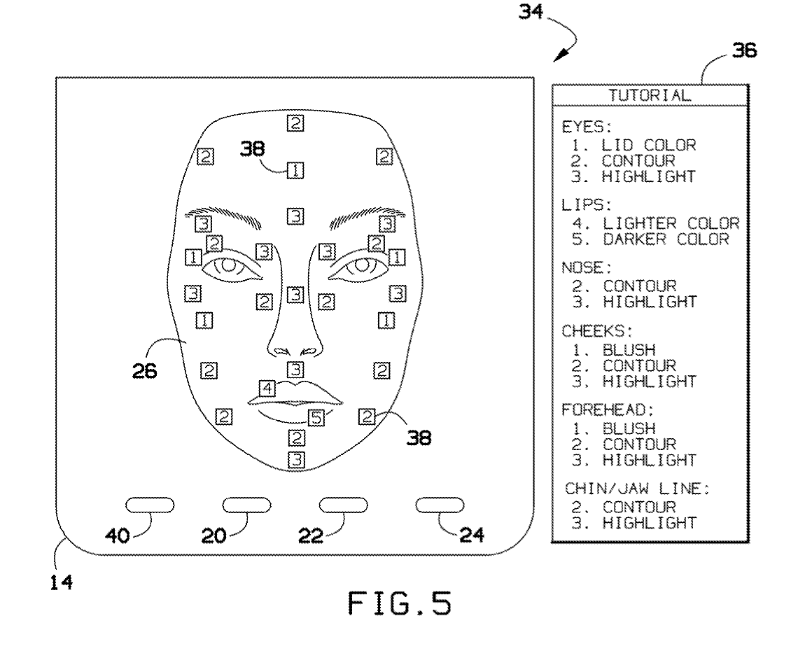

FIGS. 1-4 show a portable mirror 10 according to an exemplary embodiment of the present invention. The portable mirror 10 may include a housing 11 including an upper lid 12, a lower lid 14, and a hinge 28 to connect the upper lid 12 with the lower lid 14. A closure latch 32 may secure the upper lid 12 to the lower lid 14.

The housing 11 may be made of a sturdy material, for example, plastic, polymer, metal, wood, or composite material. The size of the housing 11 may depend on the user's preferences. The size of the housing 11 may be, for example, approximately ten inches long, approximately ten inches wide, and approximately one inch thick.

The upper lid 12 may include a mirror 18 surrounded by a plurality of lights 16. The mirror 18 may be a commercially available mirror, for example, a magnifying mirror.

Lights 16 may be a commercially available light, for example, light emitting diodes (LED).

A power cord 30 may be secured to the housing 11. The power cord 30 may provide the portable mirror 10 with electrical power. In addition, the portable mirror 10 may be powered by using batteries (not shown).

As can be seen in FIG. 2, the upper lid 12 may be raised from the lower lid 14 by pressing the closure latch 32. The hinge 28 may allow the upper lid 12 to remain in the open position without any additional support.

The lower lid 14 may be slightly heavier than the upper lid 12 to insure stability of the portable mirror device 10 when the mirror device 10 is in the open position.

The lower lid 14 may include an on/off switch 20 to turn on or turn off the lights 16 on the portable mirror 10. A daytime switch 22 may be activated to support daytime makeup application by providing the bright lighting. A nighttime switch 24 may be used to support nighttime makeup application by providing dimmer lighting.

A tutorial 34 may be included on the lower lid. The tutorial 34 may include written instructions 36 that may show the user the appropriate areas to which the user should apply makeup and the type of makeup to be applied, for example, eyelid color, contour, and highlights; cheek color, contour, and highlights; nose contour and highlights; lip color, highlights, and contour; chin contour and highlights; as well as jaw highlights and contour.

A diagram 26 may be placed on the lower lid 14. The diagram 26 may resemble the face of a woman. The diagram 26 may guide the user (not shown) through the proper application of makeup. Each area of the diagram 26 may be marked with numbers 38 that correspond to numbers on the written tutorial 36.

The user may follow the written instructions 36 to apply the makeup on the area of the face, based on the numbers 38 provided by the diagram 26.

Audible recorded instructions on how to apply makeup may be activated and deactivated by a recorder tutorial on/off switch 40 located on the lower lid 14.

The daytime switch 22, the nighttime switch 24, and/or the recorder tutorial on/off switch 40 may be touch pad switches, with no portions raised away from the lower lid 14.

A cover (not shown) may be placed on top of the lower lid 14 to protect the switches 22, 24, and/or 40 from inadvertent damage.

A carrying case (not shown) may be included to protect the portable mirror while traveling.

The illuminated mirror 10 may provide the user with a source of magnification, illumination, and guidance for applying makeup.

In some embodiments, the diagram 26 may include a plurality of removable different makeup overlays having different makeup styles and/or color combinations.

It should be understood, of course, that the foregoing relates to exemplary embodiments of the invention and that modifications may be made without departing from the spirit and scope of the invention as set forth in the following claims.

What is claimed is:

1. A portable mirror comprising:
a housing including an upper lid, a lower lid, and a hinge connecting the upper lid to the lower lid;
a closure latch to secure the upper lid to the lower lid;
a mirror connected to the upper lid;
a plurality of lights surrounding the mirror; and
a tutorial attached to the lower lid;
wherein the tutorial includes written instructions on how to apply makeup.

2. The portable mirror according to claim 1, wherein the mirror is a magnifying mirror.

3. The portable mirror according to claim 1, wherein the lights are light emitting diodes.

4. The portable mirror according to claim 1, further comprising a power cord for electrically connecting the portable mirror to a power supply.

5. The portable mirror according to claim 1, wherein the portable mirror is powered by batteries.

6. The portable mirror according to claim 1, further including an on/off switch to turn on or turn off the lights.

7. The portable mirror according to claim 1, further including a daytime switch to provide bright lighting.

8. The portable mirror according to claim 1, further including a nighttime switch to provide dimmer lighting.

9. The portable mirror according to claim 1, further including a diagram on the lower lid, the diagram resembles the face of a woman, the diagram includes numbers that correspond to numbers on the written instructions.

10. The portable mirror according to claim 1, further including audible recorded instructions that are activated and deactivated by a recorder tutorial on/off switch.
